(19) United States
(12) Patent Application Publication
(10) Pub. No.: US 2015/0121361 A1
(43) Pub. Date: Apr. 30, 2015

(54) Software Installation Method, Device And System

(71) Applicant: TENCENT TECHNOLOGY (SHENZHEN) COMPANY LIMITED, Shenzhen City (CN)

(72) Inventors: Shiping LI, Shenzhen (CN); Xin TUO, Shenzhen (CN)

(21) Appl. No.: 14/571,999

(22) Filed: Dec. 16, 2014

Related U.S. Application Data
(63) Continuation of application No. PCT/CN2013/077864, filed on Jun. 25, 2013.

(30) Foreign Application Priority Data
Jun. 25, 2012 (CN) 201210209732.2

(51) Int. Cl. G06F 9/445; H04L 29/08

(52) U.S. Cl. CPC G06F 8/61; H04L 67/10
USPC 717/175

(57) ABSTRACT

A software installation method, device and system. The method includes: downloading a software installation package; detecting type of the software installation package; installing the software installation package in a parallel software installation mode if the type of the software installation package is not Microsoft Installer (MSI) type; and installing the software installation package in a serial software installation mode if the type of the software installation package is the MSI type.

### CROSS-REFERENCE TO RELATED APPLICATIONS

This application is a continuation of International Application No. PCT/CN2013/077864, filed on Jun. 25, 2013. This application claims the benefit and priority of Chinese Application No. 201210209732.2, filed Jun. 25, 2012. The entire disclosures of each of the above applications are incorporated herein by reference.

### FIELD

The present disclosure relates to a software installation method, device and system.

### BACKGROUND

This section provides background information related to the present disclosure which is not necessarily prior art.

With the rapid development of computer technologies and network technologies, Internet technologies play a more and more important role in peoples' daily lives, studies, and work. Furthermore, there may be various kinds of software on the Internet, which indirectly promotes the development of managing software. The managing software is a tool capable of downloading software and performing management and is classified as detection software, downloading software, installation software, and uninstallation software.

### SUMMARY

This section provides a general summary of the disclosure, and is not a comprehensive disclosure of its full scope or all of its features.

Various embodiments of the present disclosure provide a software installation method to enhance installation efficiency of the software. Various embodiments of the present disclosure provide a software installation device to enhance the installation efficiency of the software. Various embodiments of the present disclosure provide a software installation system to enhance the installation efficiency of the software.

Various embodiments of the present disclosure provide a software installation method, including:

downloading a software installation package;
detecting type of the software installation package;
installing the software installation package in a parallel software installation mode if the type of the software installation package is not Microsoft Installer (MSI) type; and
installing the software installation package in a serial software installation mode if the type of the software installation package is the MSI type.

Various embodiments of the present disclosure provide a software installation device, including:

a software installation package downloading unit to download a software installation package;
a software installation package type determination unit to detect the type of the software installation package;
a software installation unit to install the software installation package in a parallel software installation mode if the type of the software installation package is not Microsoft Installer (MSI) type and install the software installation package in a serial software installation mode if the type of the software installation package is the MSI type.

Various embodiments of the present disclosure provide a software installation system, including:

a server to detect type of a software installation package and provide a client terminal with the software installation package; and
the client terminal to install the software installation package in a parallel software installation mode if the type of the software installation package is not Microsoft Installer (MSI) type and install the software installation package in a serial software installation mode if the type of the software installation package is the MSI type.

It can be seen from the above technical scheme that in various embodiments of the present disclosure, after the software installation package is downloaded, the type of the software installation package may be detected first. When the type of the software installation package is not the MSI type, the software installation package may be installed in the parallel software installation mode. When the type of the software installation package is the MSI type, the software installation package may be installed in the serial software installation mode. It can be seen that with the embodiments of the present disclosure, the software installation package of the MSI type and the software installation package of the non-MSI type may be processed in different ways. That is, the software installation package of the MSI type may be serially installed and the software installation package of the non-MSI type may be installed in parallel. In various embodiments of the present disclosure, since the software installation package of the non-MSI type may be installed in parallel, the problem of a long wait time in the software installation process may be solved and the software installation efficiency may be enhanced.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart illustrating a software installation method in accordance with various embodiments of the present disclosure;

FIG. 2 is a flow chart illustrating a software installation method in accordance with various embodiments of the present disclosure;

FIG. 3 is a diagram illustrating structure of a software installation device in accordance with various embodiments of the present disclosure; and

FIG. 4 is a diagram illustrating a software installation system in accordance with various embodiments of the present disclosure.

Corresponding reference numerals indicate corresponding parts throughout the several views of the drawings.

### DETAILED DESCRIPTION

Example embodiments will now be described more fully with reference to the accompanying drawings.

As for current various kinds of managing software, the same technologies are applied to a software installation module. That is, after a piece of software in a downloading queue has been downloaded and moved out of the downloading queue, the downloaded software will be added to a to-be-installed queue for installation. As for the software in the to-be-installed queue, a piece of software will be installed serially each time. That is, when an installation queue is not empty and one piece of software is in an installation status, other software may be installed after installation of the current software is completed.

However, with continuous enhancement of Internet access bandwidth, downloading speed of the software becomes faster and faster, which means that there may be multiple pieces of software in the installation status. In this case, installation efficiency may be reduced if serial installation is executed.

Furthermore, in some scenarios, after a user triggers a software installation package, the user may forget to execute the installation process (for instance, the user may operate other interfaces or software in this moment), resulting in an installation window that may be covered by an active window. However, the installation package may keep waiting for input by the user to execute the installation. operation, resulting in long installation process.

After analysis, a reason for not installing the managing software in parallel may be that as for software made by a Microsoft Installer (MSI) installation tool, if multiple installation packages made by the MSI installation tool, i.e. MSI installation packages, run simultaneously, the first MSI installation package in a running status may be normally installed and error dialog boxes may be popped up for other MSI installation packages.

To address the foregoing problems, in various embodiments of the present disclosure, installation packages may be distinguished according to the types of installation packages. For instance, the software installation packages may be classified into two types, i.e. an MSI type and a non-MSI type. An installation package of the MSI type may be serially installed. An installation package of the non-MSI type may be installed in parallel.

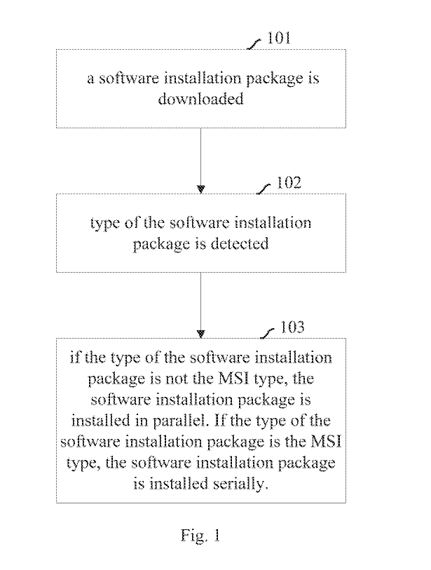

FIG. 1 is a flow chart illustrating a software installation method in accordance with various embodiments of the present disclosure.

As shown in FIG. 1, the method may include following blocks.

Block 101: a software installation package may be downloaded. A user may download the software installation package from the Internet via a variety of ways. The software installation package may be a collection of files obtained by auto-decompression and may include all files needed for installing the software. The software installation package may be executed (the software installation package may generally include an executable file) and all files associated with the software may be released to a hard disk to finish operations, such as modifying a registry, modifying system settings, and creating a shortcut. Presently, the format of the software installation package may generally be exe.

The software installation package may be downloaded via a Hypertext transfer protocol (HTTP) downloading mode, a File Transfer Protocol (FTP) downloading mode, a Bit Torrent (BT) downloading mode, a cdn dedicated downloader, a media downloading, etc. Presently, the HTTP downloading mode and FTP downloading mode may be two common downloading modes.

The HTTP and FTP may be abbreviations of two kinds of network transfer protocols. The FTP may be the abbreviation of File Transfer Protocol and the HTTP may be the abbreviation of the Hyper Text Transfer protocol. The HTTP and FTP may be two modes used for exchanging data between computers and may be two of the most common file downloading modes. Before performing the downloading using the FTP or the HTTP, the user may need to obtain a valid resource link or server address and obtain the software installation package by connecting to the resource link or server address.

Block 102: type of the software installation package may be detected.

When downloading of a piece of software is completed, the type of the software installation package may be analyzed first and a determination as to whether the software installation package is the MSI type may be made. As for the software installation package of the MSI type, it may be ensured that only one installation package of the MSI type may run at the same time. As for the software installation package of the non-MSI type, the software installation package may be executed immediately and may be installed in parallel.

The software installation package may be an executable binary file (extension of the file may be “.exe”). The type of the software installation package may be detected via analyzing a file header of the software installation package. The method for detecting the type of the software installation package may include: reading the file header of the software installation package, searching for the type of the software installation package corresponding to a characteristic value in a database according to the characteristic value in the file header, and detecting the type of the software installation package.

For instance, as for the software installation package made by NullsoftInst (NSIS), the file header of the software installation package may include a character string “NullsoftInst” to denote that the software installation package may be made according to an NSIS technology. The software installation package made by the MSI may include a character string “Windows Installer” to denote that the software installation package may be made according to an MSI technology.

The MSI file is a data package of a Windows Installer. The MSI file may include information needed for installing a product and instructions and data needed for installing (uninstalling) the software in many cases. In the MSI file, the files constituting the software and functions may be associated. Furthermore, the MSI file may further include information relating to the installation process, such as an installation sequence, a target folder path, a system dependency, an installation option, and an attribute for controlling the installation process.

Table 1 is correlation table of the type of software installation package and the characteristic value of the file header.

TABLE 1

| Type of the | |
|---|---|
| installation package | Characteristic value |
| MSI | Windows Installer |
| NSIS | NullsoftInst |
| Inno | Inno Setup |
| wise | Wise Installation |

Based on the above Table 1, the method for detecting the type of the software installation package according to the characteristic value in the file header may include: determining that the type of the software installation package may be the MSI type when the characteristic value in the abstracted file header is Windows Installer and determining that the type of the software installation package is not the MSI type when the characteristic value in the file header is not the Windows Installer.

For instance, when the characteristic value in the file header is the Windows Installer, it may be determined that the type of the software installation package is the MSI type. When the characteristic value in the file header is the NullsoftInst, it may be determined that the type of the software installation package is the NSIS. When the characteristic value in the file header is the Inno Setup, it may be determined that the type of the software installation package is Inno. When the characteristic value in the file header is the Wise Installation, it may be determined that the type of the software installation package is Wise.

Characteristic values in the file headers of the common software installation packages are listed in the above Table 1. It should be well known to one with ordinary skilled in the art that the above table may be an example and may not be used for limiting protection scope of the present disclosure. The characteristic value in the file header of the software installation package may be adjusted according to the type of the software installation package.

According to various embodiments, the type of the software installation package may be detected by a server providing the software installation package or may be detected by a client terminal downloading the software installation package.

If the type of the software installation package is detected by the server, the type of the software installation package may be recorded in the server, and the client terminal will not need to analyze the type of the software installation package. After the server detects the type of the software installation package, an artificial check mechanism may be set in the server. That is, after the server automatically analyzes the type of the software installation package, assist characteristic of the software installation package may be manually parsed to check the type of the software installation package again and ensure the accuracy of the type of the software installation package.

According to various embodiments, the assist characteristic may include: a window style and/or window class name in a software installation process.

Furthermore, in a process for detecting the type of the software installation package according to the characteristic value, characteristic value matching may be performed by searching for an ansi character string or searching for a unicode character string. According to various embodiments, the characteristic value matching may be performed by searching for the ansi character string and unicode character string.

Block 103: if the type of the software installation package is not the MSI type, the software installation package may be installed in parallel. If the type of the software installation package is the MSI type, the software installation package may be installed serially.

According to various embodiments, the software installation package of the MSI type and the software installation package of the non-MSI type may be processed in different ways. As for the software installation package of the MSI type (first installation package), if there is another software installation package of the MSI type, which is being installed (second installation package), the software installation package of the MSI type (i.e. the first software installation package) may not be immediately installed. The software installation package (the first installation package) may be installed after the installation of the software installation package (i.e. the second software installation package), which is being installed, is finished. When the second software installation package is being installed, nothing is done until the installation of the second software installation package is finished. When the installation of the second software installation package is finished, the first software installation package may be installed.

The software installation packages of the non-MSI type may be installed in parallel. Regardless of whether the task for installing the software installation package is being executed, the software installation package may be directly installed. That is, the software installation package may be installed after the downloading of the software installation package is finished.

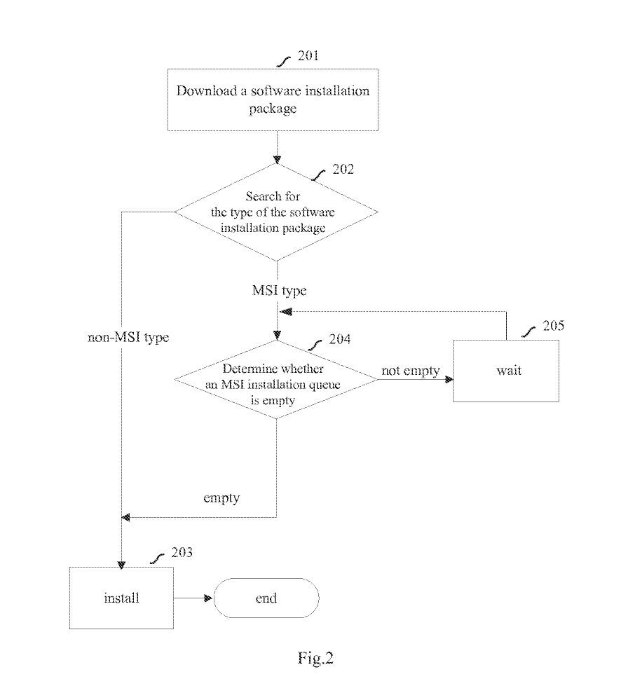

FIG. 2 is a flow chart illustrating another software installation method in accordance with various embodiments of the present disclosure.

As shown in FIG. 2, the method may include following blocks.

Block 201: a client terminal may download a software installation package.

Block 202: the client terminal may search for the type of the software installation package. If the type of the software installation package is MSI type, block 204 and subsequent blocks may be performed. If the type of the software installation package is not the MSI type, i.e., is non-MSI type, block 203 and subsequent blocks may be performed.

Block 203: the downloaded software installation package may be directly installed and this flow may be terminated.

Block 204: the client terminal may determine whether an MSI installation queue is empty. If the MSI installation queue is empty, block 203 and subsequent blocks may be performed. If the MSI installation queue is not empty, block 205 and subsequent blocks may be performed.

Block 205: the client terminal may execute the block 204 and subsequent blocks after a preset time threshold.

It can be seen from the above flow that when the type of the software installation package is the MSI type, the software installation package may not be immediately installed. It may be determined first whether the MSI installation queue is empty. If the MSI installation queue is empty, the software installation package may be directly installed. If the MSI installation queue is not empty, the software installation package may be installed after the task for installing the MSI software package, which is being executed, is finished.

Based on the above analysis, various embodiments of the present disclosure may further provide a software installation device.

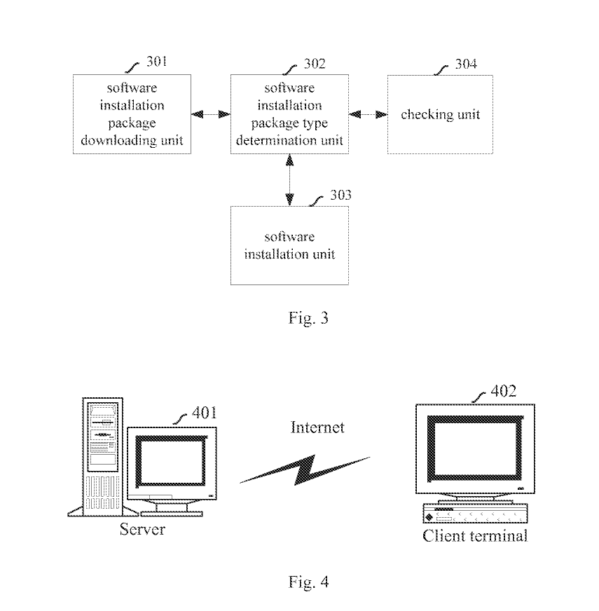

FIG. 3 is a diagram illustrating a software installation device in accordance with various embodiments of the present disclosure.

As shown in FIG. 3, the device may include: a software installation package downloading unit 301, a software installation package type determination unit 302, and a software installation unit 303.

The software installation package downloading unit 301 may be configured to download a software installation package.

The software installation package type determination unit 302 may be configured to detect type of the software installation package.

The software installation unit 303 may be configured to install the software installation package in a parallel software installation mode when the type of the software installation package is not MSI type and install the software installation package in a serial software installation mode when the type of the software installation package is the MSI type.

According to various embodiments, the software installation unit 303 may be further configured to determine whether there is a task for installing another software installation package of the MSI type when the type of the software installation package is the MSI type and wait for the task for installing the another software installation package of the MSI type, which is being performed, is finished if there is the task for installing the another software installation package of the MSI type and install the software installation package of the MSI type after the task for installing the another software installation package of the MSI type, which is being performed, is finished.

According to various embodiments, the software installation unit 303 may be further configured to directly install the software installation package, the type of which is not the MSI type, regardless of whether a task for installing a software installation package is being executed.

According to various embodiments, the software installation package type determination unit 302 may be further configured to read a file header of the software installation package, obtain a characteristic value from the file header, search for type of the software installation package corresponding to the characteristic value in a database, and detect the type of the software installation package.

The software installation package type determination unit 302 may be further configured to detect that the type of the software installation package is the MSI type when the characteristic value in the file header is the Windows Installer and detect that the type of the software installation package is not the MSI type when the characteristic value in the file header is not the Windows Installer.

For instance, when the characteristic value in the file header is NullsoftInst, it may be determined that the type of the software installation package is NSIS. When the characteristic value in the file header is Inno Setup, it may be determined that the type of the software installation package is Inno. When the characteristic value in the file header is Wise Installation, it may be determined that the type of the software installation package is Wise.

The system may further include a checking unit 304.

The checking unit 304 may be configured to parse assist characteristic of the software installation package to check the type of the software installation package after the software installation package type determination unit 302 detects the type of the software installation package.

The assist characteristic of the software installation package may include: a window style and/or window class name, etc., in a software installation process.

Based on the above analysis, various embodiments of the present disclosure may further provide a software installation system.

FIG. 4 is a diagram illustrating a software installation system in accordance with various embodiments of the present disclosure. The system may include a client terminal and a server, which may adequately utilize advantages of the hardware environment of the two sides.

As shown in FIG. 4, the system may include a server 401 and a client terminal 402 connected with each other via the Internet.

The server 401 may adopt a high-performance Personal Computer (PC), a workstation, a small-scale machine, and may adopt a large-scale database system, such as Oracle, Sybase, Informix or SQL Server. Dedicated client terminal downloading software may be installed in the client terminal 402.

The server 401 may be configured to detect type of a software installation package and provide the client terminal 402 with the software installation package.

The client terminal 402 may be configured to install the software installation package in a parallel software installation mode when the type of the software installation package is not MSI type and install the software installation package in a serial software installation mode when the type of the software installation package is the MSI type.

According to various embodiments, the client terminal 402 may be further configured to determine whether there is a task for installing another software installation package of the MSI type when the type of the software installation package is the MSI type and wait for that the task for installing the another software installation package of the MSI type, which is being performed, is finished if there is the task for installing the another software installation package of the MSI type and install the software installation package of the MSI type after the task for installing the another software installation package of the MSI type, which is being performed, is finished.

According to various embodiments, the client terminal 402 may be further configured to directly install the software installation package, the type of which is not the MSI type, regardless of whether a task for installing a software installation package is being executed.

According to various embodiments, the server 401 may be further configured to read a file header of the software installation package, obtain a characteristic value of the file header, search for type of the software installation package corresponding to the characteristic value in a database, and detect the type of the software installation package.

The server 401 may be further configured to detect that the type of the software installation package is the MSI type when the characteristic value in the file header is the Windows Installer and detect that the type of the software installation package is not the MSI type when the characteristic value in the file header is not the Windows Installer.

For instance, when the characteristic value in the file header is NullsoftInst, it may be determined that the type of the software installation package is NSIS. When the characteristic value in the file header is Inno Setup, it may be determined that the type of the software installation package is Inno. When the characteristic value in the file header is Wise Installation, it may be determined that the type of the software installation package is Wise.

The server 401 may be further configured to parse assist characteristic of the software installation package to check the type of the software installation package after the type of the software installation package is detected.

The assist characteristic of the software installation package may include: a window style and/or window class name, etc., in a software installation process.

It can be seen from the above technical scheme that in various embodiments of the present disclosure, after the software installation package is downloaded, the type of the software installation package may be detected first. When the type of the software installation package is not the MSI type, the software installation package may be installed in the parallel software installation mode. When the type of the software installation package is the MSI type, the software installation package may be installed in the serial software installation mode. It can be seen that according to various embodiments of the present disclosure, the software installation package of the MSI type and the software installation package of the non-MSI type may be processed in different ways. That is, the software installation package of the MSI type may be serially installed and the software installation package of the non-MSI type may be installed in parallel. In various embodiments of the present disclosure, since the software installation package of the non-MSI type may be installed in parallel, the problem of a long wait time in the software installation process may be solved and the software installation efficiency may be enhanced.

In the parallel software installation process, each software installation package satisfying the condition may activate its window when the installation of the software installation package begins. Therefore, it may be avoided that the user forgets to input in the software installation process. Therefore, according to various embodiments of the present disclosure, the installation time may be reduced and the user may be prompted to input in the software installation process.

According to various embodiments of the present disclosure, the software installation device and system may be constituted and the software installation method may be implemented by running a machine-readable program (including program codes) capable of executing the software installation method on a machine, such as a computer including a processing component, such as a Central Processing Unit (CPU) and a storage component, such as a Random Access Memory (RAM) or a Read Only Memory (ROM). The machine-readable program may be recorded in a machine-readable recording medium and loaded onto the machine via a machine-readable recording medium for running on the machine. When the machine-readable program runs on the machine, the program codes may execute each step of the software installation method.

The foregoing description only describes preferred embodiments of the present invention and is not used for limiting the protection scope thereof. Any modification, equivalent substitution, or improvement made without departing from the spirit and principle of the present invention should be covered by the protection scope of the present invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A software installation method, comprising:
downloading a software installation package;
detecting type of the software installation package;
installing the software installation package in a parallel software installation mode if the type of the software installation package is not Microsoft Installer (MSI) type; and
installing the software installation package in a serial software installation mode if the type of the software installation package is the MSI type.

2. The method according to claim 1, wherein installing the software installation package in the serial software installation mode comprises:
determining whether a task for installing a first software installation package of the MSI type is being executed and waiting for that the task for installing the first software installation package of the MSI type, which is being executed, is finished if the task for installing the first software installation package of the MSI type is being executed; and
installing the software installation package of the MSI type when the task for installing the first software installation package of the MSI type, which is being executed, is finished.

3. The method according to claim 1, wherein installing the software installation package in the parallel software installation mode comprises:
installing the software installation package no matter whether a task for installing a second software installation package is being executed.

4. The method according to claim 1, wherein detecting the type of the software installation package comprises:
detecting the type of the software installation package by a server providing the software installation package; or
detecting the type of the software installation package by a client terminal downloading the software installation package.

5. The method according to claim 1, wherein detecting the type of the software installation package comprises:
reading a file header of the software installation package;
obtaining a characteristic value from the file header;
searching for the type of the software installation package corresponding to the characteristic value in a database; and
detecting the type of the software installation package according to the characteristic value.

6. The method according to claim 5, wherein detecting the type of the software installation package according to the characteristic value comprises:
detecting that the type of the software installation package is the MSI type when the characteristic value in the file header is Windows Installer; and
detecting that the type of the software installation package is not the MSI type when the characteristic value in the file header is not the Windows Installer.

7. The method according to claim 1, wherein further comprising:
parsing an assist characteristic of the software installation package; and
re-checking the type of the software installation package.

8. The method according to claim 7, wherein the assist characteristic of the software installation package comprises:
a window style and/or window class name in a software installation process.

9. A software installation device, comprising:
a software installation package downloading unit, to download a software installation package;
a software installation package type determination unit, to detect type of the software installation package;
a software installation unit, to install the software installation package in a parallel software installation mode if the type of the software installation package is not Microsoft Installer (MSI) type and install the software installation package in a serial software installation mode if the type of the software installation package is the MSI type.

10. The device according to claim 9, wherein
the software installation unit is further to determine whether a task for installing a first software installation package of the MSI type is being executed when the type of the software installation package is the MSI type and wait for that the task for installing the first software installation package of the MSI type, which is being executed, is finished if the task for installing the first software installation package of the MSI type is being executed and install the software installation package of the MSI type when the task for installing the first software installation package of the MSI type, which is being executed, is finished.

11. The device according to claim 9, wherein
the software installation unit is further to install, when the type of the software installation package is not the MSI type, the software installation package no matter whether a task for installing a second software installation package is being executed.

12. The device according to claim 9, wherein
the software installation package type determination unit is further to read a file header of the software installation package, obtain a characteristic value from the file header, search for the type of the software installation package corresponding to the characteristic value in a database and detect the type of the software installation package according to the characteristic value.

13. The device according to claim 12, wherein the software installation package type determination unit is further to detect that the type of the software installation package is the MSI type when the characteristic value in the file header is Windows Installer and detect that the type of the software installation package is not the MSI type when the characteristic value in the file header is not the Windows Installer.

14. The device according to claim 9, further comprising:
a checking unit, to parse an assist characteristic of the software installation package and re-check the type of the software installation package after the software installation package type determination unit detects the type of the software installation package.

15. The device according to claim 14, wherein the assist characteristic of the software installation package comprises:
a window style and/or window class name in a software installation process.

16. A software installation system, comprising:
a server, to detect type of a software installation package and provide a client terminal with the software installation package; and
the client terminal, to install the software installation package in a parallel software installation mode if the type of the software installation package is not Microsoft Installer (MSI) type and install the software installation package in a serial software installation mode if the type of the software installation package is the MSI type.

17. The system according to claim 16, wherein
the client terminal is further to determine whether a task for installing a first software installation package of the MSI type is being executed when the type of the software installation package is the MSI type and wait for that the task for installing the first software installation package of the MSI type, which is being executed, is finished if the task for installing the first software installation package of the MSI type is being executed and install the software installation package of the MSI type when the task for installing the first software installation package of the MSI type, which is being executed, is finished.

18. The system according to claim 16, wherein
the client terminal is further to install, when the type of the software installation package is not the MSI type, the software installation package no matter whether a task for installing a second software installation package is being executed.

19. The system according to claim 16, wherein
the server is further to read a file header of the software installation package, obtain a characteristic value from the file header, search for the type of the software installation package corresponding to the characteristic value in a database and detect the type of the software installation package according to the characteristic value.

20. The system according to claim 19, wherein
the server is further to detect that the type of the software installation package is the MSI type when the characteristic value in the file header is Windows Installer and detect that the type of the software installation package is not the MSI type when the characteristic value in the file header is not the Windows Installer.
